(19) United States
(12) Patent Application Publication
(10) Pub. No.: US 2017/0327715 A1
(43) Pub. Date: Nov. 16, 2017

(54) RELEASE SHEET AND PRESSURE-SENSITIVE ADHESIVE ARTICLE

(71) Applicant: Lintec Corporation, Tokyo (JP)

(72) Inventors: Sou MIYATA, Tokyo (JP); Chiharu HIRANO, Tokyo (JP); Ryo TAKAHASHI, Tokyo (JP); Koji MIYAMOTO, Tokyo (JP)

(73) Assignee: Lintec Corporation, Tokyo (JP)

(21) Appl. No.: 15/522,751

(22) PCT Filed: Oct. 28, 2015
(86) PCT No.: PCT/JP2015/080415

§ 371 Date: Jul. 31, 2017

(30) Foreign Application Priority Data
Oct. 30, 2014 (JP) 2014-222041

(51) Int. Cl. C09J 7/02; B32B 27/40; B32B 7/12; B32B 27/36

(52) U.S. Cl. CPC C09J 7/025; B32B 27/36; B32B 27/40; B32B 7/12; B32B 2309/105; C09J 2409/005; C09J 2467/006; C09J 2475/001; C09J 2201/606

(57) ABSTRACT

A release sheet 1 may include a base material 12 and a release agent layer 11 provided on the base material 12. The release agent layer 11 is composed of a cured product of a release agent composition containing 50 mass % or more of a diene-based polymer. Mooney viscosity (ML₁₊₄ (100° C.)) of the diene-based polymer measured at 100° C. according to HS K6300 is in the range of 25 to 70, and a ratio (T_{Cp}/ML₁₊₄ (100° C.)) of the Mooney viscosity (ML₁₊₄ (100° C.)) and a viscosity (T_{Cp}) of a toluene solution of the diene-based polymer is 2.2 or less. This makes it possible to provide a release sheet which can sufficiently suppress adverse effects on electric components and the like, which has a small dependence of release force on peel rate and which can suppress the occurrence of zipping phenomenon, and a pressure-sensitive adhesive article having such a release sheet.

### TECHNICAL FIELD

The present invention relates to a release sheet and a pressure-sensitive adhesive article.

### RELATED ART

Electric components such as relays, various switches, connectors, motors, and hard disk drives are widely used in various products.

In these electric components, a pressure-sensitive adhesive sheet is attached for various purposes such as temporal tacking of parts during assembly and indication of the contents.

Such a pressure-sensitive adhesive sheet is generally composed of a pressure-sensitive adhesive sheet base and a pressure-sensitive adhesive layer, and it is being kept in a state of adhering to a release sheet until it is attached to an electric component.

This release sheet (on the side of the surface to be in contact with the pressure-sensitive adhesive layer) includes a release agent layer for a purpose of improving releasability. Conventionally, a silicone resin has been used as a constituent material of the release agent layer (see, e.g., Patent Document 1).

However, it is known that when such a release sheet is attached to a pressure-sensitive adhesive sheet, a silicone compound such as a low-molecular weight silicone resin, siloxane, silicone oil, or the like contained in the release agent layer of the release sheet is transferred to the pressure-sensitive adhesive layer of the pressure-sensitive adhesive sheet. Further, the release sheet is wound up in a rolled form after the production thereof. In this state, the back surface of the release sheet is in contact with the release agent layer thereof so that the silicone compound contained in the silicone resin (in the release agent layer) is transferred to the back surface of the release sheet. In this regard, it is also known that the silicone compound transferred to the back surface of the release sheet is re-transferred to a surface of a pressure-sensitive adhesive sheet when a pressure-sensitive adhesive article is wound up in a rolled form in manufacturing the pressure-sensitive adhesive article. Therefore, in a case where the pressure-sensitive adhesive sheet, to which such a release sheet has adhered, is attached to an electric component, the silicone compound transferred to the pressure-sensitive adhesive layer or the surface of the pressure-sensitive adhesive sheet gradually vaporizes. The vaporized silicone compound is deposited on, for example, a surface of an electric contact portion of the electric component due to electric arc or the like generated near the electric contact portion. As a result, it is known to form a minute silicone compound layer or a silicon oxide-based compound layer derived from a silicone compound.

If such a silicone compound or such a silicon oxide-based compound derived from the silicone compound is deposited on the surface of the electric contact portion, there is a case where electric conductivity becomes poor.

Particularly, in a case where such a pressure-sensitive adhesive sheet is attached to a hard disk drive, the silicone compound transferred to the pressure-sensitive adhesive layer or the surface of the pressure-sensitive adhesive sheet gradually vaporizes. After that, the silicone compound or the silicon oxide-based compound derived from the silicone compound is deposited on a magnetic head, a disk surface, or the like. As a result, there is a possibility that deposition of the minute silicone compound or the silicon oxide-based compound gives rise to adverse effects on reading and writing of data from and to a disk of the hard disk drive.

In order to solve the above problems, attempts to develop a non-silicone-based release agent containing no silicone compound have been made (see, e.g., Patent Document 2).

However, a release sheet constituted of such a non-silicone-based release agent tends to require a higher release force when the release sheet is peeled off at high speed than at low speed.

In order to prevent the higher release force, have been made attempts to constitute a release agent layer by using a polybutadiene compound having a certain range of molecular weight or Mooney viscosity, etc. (see, e.g., Patent Document 3).

However, in the release sheet of Patent Document 3, it is difficult to suppress a phenomenon in which the release force changes intermittently while peeling off the pressure-sensitive adhesive sheet from the release sheet at high speed, so-called zipping phenomenon. When the zipping phenomenon occurs, a bar code-like peeling mark remaining on the surface of the pressure-sensitive adhesive layer causes problems such as an appearance problem of the pressure-sensitive adhesive sheet or a problem in which original tackiness is not obtained. In addition, an error occurs when the pressure-sensitive adhesive sheet is automatically attached to the electrical component by a labeling device or the like, so that a problem of poor workability also occurs.

The Patent Document 1 is JP-A 1994-336574

The Patent Document 2 is JP-A 2004-162048

The Patent Document 3 is JP-B 5043025

### SUMMARY OF THE INVENTION

It is therefore an object of the present invention to provide a release sheet which can sufficiently suppress adverse effects on electrical components and the like, which has a small dependence of release force on peel rate and which can suppress occurrence of zipping phenomenon, and a pressure-sensitive adhesive article having such a release sheet.

The above object is achieved by the inventions (1) to (12) set forth below.

(1) A release sheet, comprising:

a base material; and
a release agent layer provided on the base material,

wherein the release agent layer is composed of a cured product of a release agent composition containing 50 mass % or more of a diene-based polymer,

wherein Mooney viscosity (ML₁₊₄ (100° C.)) of the diene-based polymer measured at 100° C. according to JIS K6300 is in the range of 25 to 70, and

wherein a ratio (T_{Cp}/ML₁₊₄ (100° C.)) of the Mooney viscosity (ML₁₊₄ (100° C.)) and a viscosity (T_{Cp}) of a toluene solution of the diene-based polymer is 2.2 or less.

(2) In the release sheet in the above-mentioned invention (1), an amount of a silicone compound contained in the release agent layer is measured by X-ray photoelectron spectroscopy (XPS), and the amount is 0.5 atomic % or less.

(3) In the release sheet described in the above-mentioned invention (1) or (2), the diene-based polymer contains cis-1,4-butadiene as a monomer.

(4) In the release sheet described in the above-mentioned invention (3), a content of the cis-1,4-butadiene as the monomer in the diene-based polymer is 90 mol % or more.

(5) In the release sheet described in any one of the above-mentioned inventions (1) to (4), the diene-based polymer has a mass average molecular weight of 100,000 to 600,000.

(6) In the release sheet described in any one of the above-mentioned inventions (1) to (5), the release agent layer has an average thickness of 0.01 to 1.0 μm.

(7) The release sheet described in any one of the above-mentioned inventions (1) to (6) further comprising an undercoat layer provided between the base material and the release agent layer.

(8) In the release sheet described in the above-mentioned invention (7), the undercoat layer is constituted of a material containing a polyurethane-based resin.

(9) In the release sheet described in any one of the above-mentioned inventions (1) to (8), the cured product of the release agent composition is formed by irradiating the release agent composition with an energy ray.

(10) In the release sheet described in any one of the above-mentioned inventions (1) to (9), the base material is one kind selected from the group consisting of paper, laminated paper obtained by laminating a thermoplastic resin on the paper, a plastic film, and a laminated sheet including them.

(11) A pressure-sensitive adhesive article comprising:

the release sheet as described in any one of the above-mentioned inventions (1) to (10); and

a pressure-sensitive adhesive sheet having a pressure-sensitive adhesive layer.

(12) In the pressure-sensitive adhesive article described in the above-mentioned invention (11), the pressure-sensitive adhesive layer is constituted of at least one kind selected from the group consisting of an acrylic-based pressure-sensitive adhesive, a polyester-based pressure-sensitive adhesive, and an urethane-based pressure-sensitive adhesive.

According to the present invention, it is possible to provide the release sheet which can sufficiently suppress the adverse effects on the electric components such as relays, various switches, connectors, motors, and hard disk drives, which has the small dependence of the release force on the peel rate and which can suppress the occurrence of the zipping phenomenon, and the pressure-sensitive adhesive article having such a release sheet.

### BRIEF DESCRIPTION OF THE DRAWINGS

FIG. 1 is a cross sectional view of a preferred embodiment of a pressure-sensitive adhesive article according to the present invention.

FIG. 2 is a cross sectional view of a preferred embodiment of a release sheet according to the present invention.

FIG. 3 is a cross sectional view of another preferred embodiment of a release sheet according to the present invention.

FIG. 4 is graphs in which (a) is a graph showing the force curve of a sample used for measurement of Young's modulus in Example 1, and (b) is a graph showing a relationship between stress (F) and sample deformation amount (5) which is used when calculating Young's modulus E of the sample used in Example 1.

FIG. 5 is graphs in which (a) is a graph showing a relationship between time and release force when zipping phenomenon does not occur in a release force test, and (b) is a graph showing a relationship between time and release force when the zipping phenomenon occurs in the release force test.

### DETAILED DESCRIPTION OF THE PREFERRED EMBODIMENTS

Hereinbelow, the present invention will be described in detail based on preferred embodiments thereof.

<Pressure-Sensitive Adhesive Article>

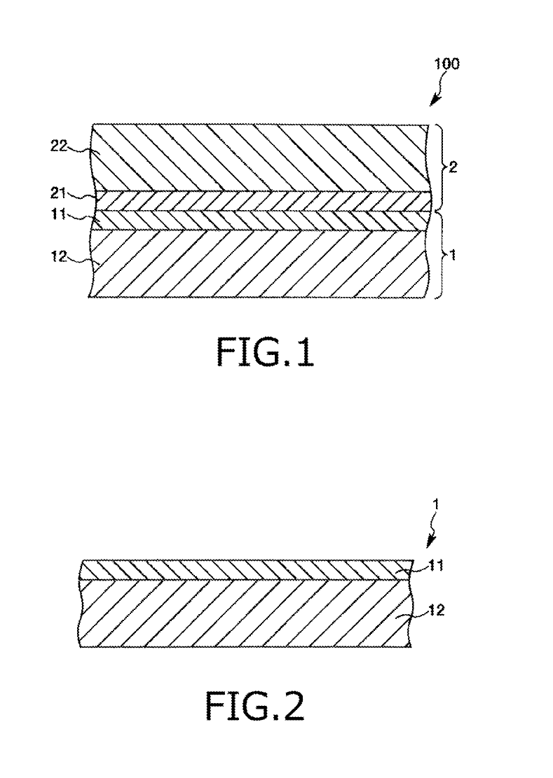

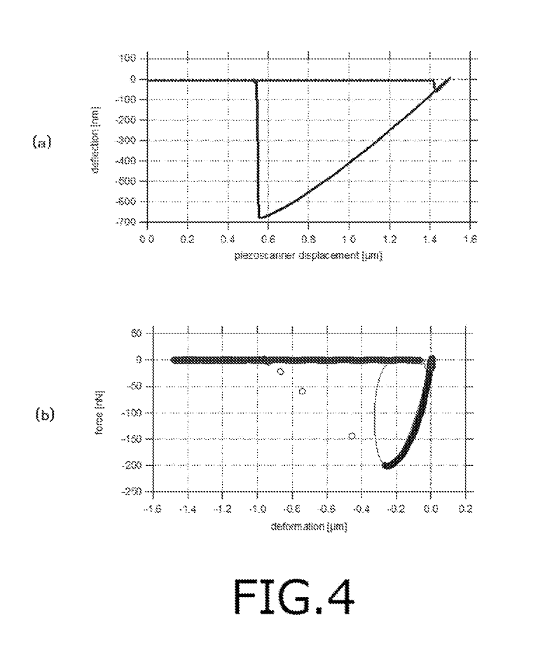

FIG. 1 is a cross sectional view of a preferred embodiment of a pressure-sensitive adhesive article according to the present invention. FIG. 2 is a cross sectional view of a preferred embodiment of a release sheet according to the present invention. FIG. 4 (a) is a graph showing the force curve of a sample used for measurement of Young's modulus in Example 1, and FIG. 4 (b) is a graph showing a relationship between stress (F) and sample deformation amount (5) which is used when calculating Young's modulus E of the sample used in Example 1. It is to be noted that in the following description, the upper side in FIGS. 1 and 2 will be referred to as “upper” or “upper side”. And the lower side in FIGS. 1 and 2 will be referred to as “lower” or “lower side”.

As shown in FIG. 1, a pressure-sensitive adhesive article 100 (a pressure-sensitive adhesive article according to the present invention) has a structure in which a pressure-sensitive adhesive sheet 2 having a pressure-sensitive adhesive layer 21 and a pressure-sensitive adhesive sheet base 22 adheres to a release sheet 1 having a release agent layer 11 constituted of a material as will be described later and a base material (a release sheet base) 12. In the pressure-sensitive adhesive article 100, the pressure-sensitive adhesive layer 21 is in contact with the release agent layer 11.

In the case of such a pressure-sensitive adhesive article 100, the pressure-sensitive adhesive sheet 2 can be peeled off from the release sheet 1.

Hereinbelow, each sheet will be described in detail.

[Release Sheet]

As shown in FIG. 2, the release sheet 1 is composed so that the release agent layer 11 is formed on the base material 12.

The base material 12 has a function of supporting the release agent layer 11.

The base material 12 is preferably one kind selected from the group consisting of paper, laminated paper obtained by laminating a thermoplastic resin on paper, a plastic film, and a laminated sheet including them. This makes it possible to more reliably support the release agent layer 11.

An average thickness of the base material 12 is not particularly limited, but is preferably in the range of 5 to 300 μm, and more preferably in the range of 10 to 200 μm.

By providing the release agent layer 11 on the base material 12, it is possible to peel off the pressure-sensitive adhesive sheet 2 from the release sheet 1.

The release agent layer 11 is composed of a cured product of a release agent composition and is formed by curing the release agent composition.

The release sheet 1 according to the present invention is characterized in that the release agent composition contains 50 mass % or more of a diene-based polymer, Mooney viscosity (ML₁₊₄ (100° C.)) of the diene-based polymer measured at 100° C. according to JIS K6300 is in the range of 25 to 70, and a ratio (T_{Cp}/ML₁₊₄ (100° C.)) of the Mooney viscosity (ML₁₊₄ (100° C.)) and a viscosity (T_{Cp}) of a toluene solution of the diene-based polymer is 2.2 or less.

By having such features, it is possible to prevent the transfer of a silicone compound from the release sheet 1 to the pressure-sensitive adhesive layer 21. As a result, it is possible to prevent the release of the silicone compound from the pressure-sensitive adhesive sheet 2 after the pressure-sensitive adhesive sheet 2 is attached to an adherend. Therefore, even when the adherend is electronic equipment such as relays, the pressure-sensitive adhesive sheet 2 is hard to give adverse effects to the adherend.

By having the features as described above, it is possible to reduce a difference between a release force required to peel off the pressure-sensitive adhesive sheet from the release sheet 1 at high speed and a release force required to peel off the pressure-sensitive adhesive sheet 2 from the release sheet 1 at low speed. That is, it is possible to lessen the dependence of the release force on the peel rate.

Further, by having the features as described above, it is possible to effectively suppress the phenomenon in which the release force changes intermittently while peeling off the pressure-sensitive adhesive sheet 2 from the release sheet 1 at high speed, so-called zipping phenomenon.

In the present invention, the Mooney viscosity (ML₁₊₄ (100° C.)) of the diene-based polymer (before curing) is in the range of 25 to 70. In this regard, the Mooney viscosity (ML₁₊₄ (100° C.)) is preferably in the range of 27 to 43 and more preferably in the range of 29 to 34. This makes it possible to make the effects of the present invention more remarkable.

Further, in the present invention, the ratio (T_{Cp}/ML₁₊₄ (100° C.)) of the Mooney viscosity (ML₁₊₄ (100° C.)) and the viscosity (T_{Cp}) of the toluene solution of the diene-based polymer is 2.2 or less. In this regard, the ratio (T_{Cp}/ML₁₊₄ (100° C.)) is preferably 2.0 or less and more preferably in the range of 1.0 to 1.8. This makes it possible to make the effects of the present invention more remarkable. On the other hand, if the ratio (T_{Cp}/ML₁₊₄ (100° C.)) exceeds the upper limit value noted above, it is impossible to sufficiently suppress the zipping phenomenon.

The viscosity (T_{Cp}) of the toluene solution of the diene-based polymer is preferably in the range of 25 to 100 and more preferably in the range of 30 to 90. This makes it possible to further lessen the dependence of the release force on the peel rate and further suppress the occurrence of the zipping phenomenon.

In this regard, the viscosity (T_{Cp}) of the toluene solution of the diene-based polymer means a viscosity which is determined by dissolving 2.28 g of the diene-based polymer into 50 ml of toluene to obtain the toluene solution and then measuring the toluene solution at 25° C. by means of a standard solution for calibrating viscometers (JIS Z 8809) as a standard solution and Canon Fenske Viscometer No. 400.

The release agent layer 11 is preferably constituted of a material containing substantially no silicone compound. This makes it possible to more reliably prevent the transfer of the silicone compound and the like from the release sheet 1 to the pressure-sensitive adhesive layer 21 of the pressure-sensitive adhesive article 100. As a result, it is possible to more reliably prevent the release of the silicone compound and the like from the pressure-sensitive adhesive sheet 2 after the pressure-sensitive adhesive sheet 2 is attached to the adherend. Therefore, even when the adherend is the electronic equipment such as relays, the pressure-sensitive adhesive sheet 2 is particularly hard to give the adverse effects to the adherend.

It is to be noted that the phrase “containing substantially no silicone compound” means an amount of the silicone compound measured by X-ray photoelectron spectroscopy (XPS) is preferably 0.5 atomic % or less and more preferably 0.1 atomic % or less. The measurement conditions of X-ray photoelectron spectroscopy (XPS) are as follows, and the amount of the silicone compound is calculated in the following manner using measured values.

Measurement instrument: Quantera SXM manufacture d by ULVAC-PHI, INC.

X-ray: AlKα (1486.6 eV)

Takeoff angel: 45°

Elements measured: silicon (Si) and carbon (C)

The amount of the silicone compound is expressed in “atomic %” calculated by multiplying the value of Si/(Si+C) by 100.

Examples of the diene-based polymer for use in forming the release agent layer 11 include polybutadiene rubber, polyisoprene rubber, styrene-butadiene rubber, styrene-isoprene rubber, and the like. Among these diene-based polymers, polybutadiene rubber (especially, 1,4-polybutadiene rubber) is particularly preferred. By using such a diene-based polymer, it is possible to provide the release sheet 1 which is hard to give adverse effects to electric components such as relays, various switches, connectors, and motors and which has a smaller dependence of the release force on the peel rate.

It is preferred that the diene-based polymer contains cis-1,4-butadiene as a monomer. This makes it possible to make the Mooney viscosity more suitable. As a result, the dependence of the release force on the peel rate can be further lessened. In addition, it is possible to make the ratio (T_{Cp}/ML₁₊₄ (100° C.)) more suitable. As a result, the occurrence of the zipping phenomenon can be suppressed more effectively. Further, by containing the cis-1,4-butadiene, a structure of 1,4-butadiene becomes a structure in which a molecular chain of 1,4-butadiene is bent due to steric hindrance of substituents on the same side in a molecular structure of the cis-1,4-butadiene, so that it is easy to have an irregular molecular structure. Furthermore, since many gaps are formed between molecular chains of 1,4-butadiene and thus, intermolecular force becomes relatively small, crystallization of the molecules does not occur. Therefore, the release agent layer 11 has a soft property. This makes it possible to suppress the zipping phenomenon.

Further, a content of the cis-1,4-butadiene as the monomer in the diene-based polymer is preferably 90 mol % or more and more preferably in the range of 93 to 99 mol %. This makes it possible to easily make the Mooney viscosity suitable. As a result, the dependence of the release force on the peel rate can be further lessened. In addition, it is possible to make the ratio (T_{Cp}/ML₁₊₄ (100° C.)) even more suitable. As a result, for the same reason as described above, the occurrence of the zipping phenomenon can be suppressed further effectively.

A mass average molecular weight of the diene-based polymer is preferably in the range of 100,000 to 600,000, and more preferably in the range of 300,000 to 550,000. This makes it possible to easily obtain the favorable Mooney viscosity, thereby further lessening the dependence of the release force on the peel rate. In addition, it is possible to make the ratio (T_{Cp}/ML₁₊₄ (100° C.)) more suitable. As a result, the occurrence of the zipping phenomenon can be suppressed more effectively.

An average thickness of the release agent layer 11 is not particularly limited, but is preferably in the range of 0.01 to 1.0 μm, more preferably in the range of 0.03 to 0.8 μm, and even more preferably in the range of 0.05 to 0.5 μm. If the average thickness of the release agent layer 11 is less than the lower limit value noted above, there is a case where releasability of the pressure-sensitive adhesive sheet 2 from the release sheet 1 is poor. On the other hand, if the average thickness of the release agent layer 11 exceeds the upper limit value noted above, there is a case where blocking is likely to occur between the release agent layer 11 and the back surface of the release sheet 1 when the release sheet 1 is wound up in a rolled form so that the releasability of the release agent layer 11 is deteriorated due to the blocking.

Examples of a method for curing the uncured release agent described above include, but are not limited to, irradiation with active energy rays such as UV rays, heating, and the like.

The release agent layer 11 may further contain another resin component and/or various additives such as oxidation inhibitors, plasticizers, stabilizers, crosslinking agents, sensitizers, and radical initiators.

Further, Young's modulus of the surface of the release agent layer 11 measured by the force curve measurement method using an atomic force microscope is preferably in the range of 0.5 to 2.3 MPa and more preferably in the range of 0.7 to 2.25 MPa. This makes it possible to make the effects of the present invention more remarkable.

The measurement of the Young's modulus is carried out by producing a test piece which is prepared by forming the release agent layer 11 having a thickness of 1 μm on the base material 12 (PET base material) having a thickness of 50 μm, and then using the force curve measurement method with the atomic force microscope (AFM).

More specifically, the Young's modulus can be measured by using, for example, MultiMode 8 AFM manufactured by Bruker AXS as the atomic force microscope, and LRCH 250 manufactured by TEAM NANOTEC as a cantilever [spring constant (nominal value 0.2 N/m, measured value by a thermal fluctuation method 0.24 N/m), a probe tip radius of 300 nm] under conditions of frequency of 4 Hz and trigger force of 1.2 nN.

In the force curve measurement method, it is possible to obtain a relationship between an amount of deflection of the cantilever and an amount of displacement of a piezo scanner when the cantilever is pushed into and separated from the release agent layer 11.

Then, the obtained force curve is converted into a relationship between a stress (F) and a sample deformation amount (5) to obtain an F-δ curve.

The F-δ curve is analyzed by Johnson-Kendall-Roberts (JKR) two-point method.

In the JKR two-point method, the Young's modulus E of a sample can be calculated by the following formula based on two points which are an equilibrium point (point A) and an cohesion point (point B) obtained in the process of separating the cantilever. When coordinates of A and B are defined as A (δ₀,0) and B (δ₁,F₁) respectively, the Young's modulus E can be expressed by the following formula (1).

$$E = \frac{3 ( 1 - {v}^{2} )}{4} {( \frac{1 + {16}^{1 / 3}}{3} )}^{3 / 2} \frac{- {F}_{1}}{\sqrt{{R ( {δ}_{0} - {δ}_{1} )}^{3}}} \qquad ( 1 )$$

In this regard, ν is a Poisson's ratio of the sample and R is a radius of curvature (300 nm) of the probe tip of the cantilever. As the value of ν, 0.5 which is a general value for polymer materials is used.

In each of Examples and Comparative Examples described later, the measurement of the force curve (FIG. 4 (a)) is carried out at 32×32 points (1024 points in total) in the plane of the release agent layer 11 of each sample (release sheet 1) having 5 μm square, and then the F-δ curve (FIG. 4 (b)) and the Young's modulus E are calculated. Thereby, an average value E_{AVE} of the Young's modulus of the surface of the release agent layer 11 is determined.

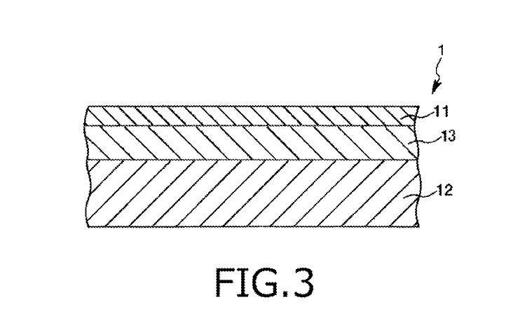

Further, in the pressure-sensitive adhesive article 100 according to the present invention, as shown in FIG. 3, an undercoat layer 13 may be provided between the release agent layer 11 and the base material 12. By providing the undercoat layer 13, the adhesion between the release agent layer 11 and the base material 12 can be improved.

Examples of a material to constitute the undercoat layer 13 include: a polyurethane-based resin such as polyurethane elastomer and modified polyurethane elastomer; an acrylic-based resin such as (meth)acrylic acid ester; a polyolefin-based resin such as ethylene vinyl acetate copolymer; a styrene-based resin such as styrene butadiene rubber; a rubber-based resin such as butyl rubber, polyisobutylene rubber and polyisoprene rubber; a natural resin such as natural rubber and the like. Among them, in particular, the polyurethane-based resin is preferably used because of having solvent resistance to an organic solvent used for a release agent solution and excellent rubber elasticity.

An average thickness of the undercoat layer 13 is not particularly limited, but is preferably in the range of 0.01 to 3 μm, and more preferably in the range of 0.05 to 1 μm. By setting the average thickness of the undercoat layer 13 to the lower limit value or more, it is possible to improve the adhesion between the release agent layer 11 and the base material 12. Further, by setting the average thickness of the undercoat layer 13 to the upper limit value or less, it is possible to suppress the blocking.

Further, an average value (Fa) of the release force, an average value (Fp) of maximum release forces and an average value (Fb) of minimum release forces of the pressure-sensitive adhesive sheet 2 are obtained from a graph showing a release force change from a peeling start to a peeling end of the pressure-sensitive adhesive sheet 2 in the release force test (10 m/min). It is preferable that a release force change ratio which is calculated based on the average values of them and the following formula (2) is 10% or less. This makes it possible to make the effects of the present invention more remarkable.

Release force change ratio (%)=[(Fp−Fb)/2Fa]×100 (2)

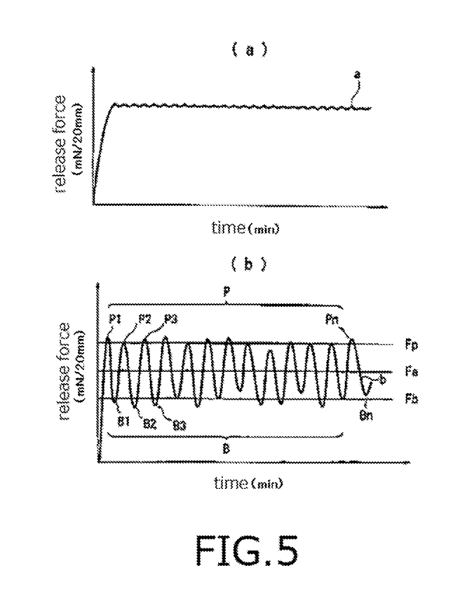

More specifically, the average value (Fa) of the release force is a value determined as follows. FIG. 5 (a) is a graph showing a relationship between time and release force when zipping phenomenon does not occur in the release force test. In this case, Fa is indicated by an average value “a” of all measurement points. On the other hand, FIG. 5 (b) is a graph showing a relationship between time and release force when zipping phenomenon occurs in the release force test. In this case, while determining an average value Fp of maximum release forces P1, P2, P3, . . . Pn at each measurement point P, an average value Fb of minimum release forces B1, B2, B3, . . . Bn at each measurement point B is determined. After that, the average value (Fa) is calculated by the formula Fa=(Fp+Fb)/2.

In this regard, the release force test (10 m/min) is carried out as follows.

1. The pressure-sensitive adhesive layer 21 having a thickness of 25 μm is formed on the surface of the release agent layer 11 of the release sheet 1.

2. A polyethylene terephthalate resin substrate (PET film) (thickness: 50 μm) is laminated on the surface of the pressure-sensitive adhesive layer 21 and seasoning is performed under an atmosphere of 23° C. and 50% RH for one week. Thereafter, the release force of the pressure-sensitive adhesive layer 21 to the release agent layer 11 is measured in accordance with JIS Z 0237. The measurement is carried out by peeling the pressure-sensitive adhesive sheet 2 of 150 mm from the release sheet 1 at a speed of 10 m/min in a direction of 180° by using a tensile tester under an atmosphere of 23° C. and 50% RH.

[Pressure-Sensitive Adhesive Sheet]

Hereinbelow, the pressure-sensitive adhesive sheet will be described.

As shown in FIG. 1, the pressure-sensitive adhesive sheet 2 has a structure in which the pressure-sensitive adhesive layer 21 is formed on a surface of the pressure-sensitive adhesive sheet base 22.

The pressure-sensitive adhesive sheet base 22 has a function of supporting the pressure-sensitive adhesive layer 21. Further, the pressure-sensitive adhesive sheet base 22 is constituted from a single body, for example, a plastic film such as a polyethylene terephthalate film, a polybutylene terephthalate film, a polyethylene film, a polypropylene film, a polymethylpentene film, a polycarbonate film, or the like; a metal foil such as an aluminum foil, a stainless steel foil, or the like; paper such as synthetic paper, lint-free paper, high quality paper, art paper, coated paper, glassine paper, or the like; or a laminate body of two or more of them.

Among them, the pressure-sensitive adhesive sheet base 22 is particularly preferably constituted from the plastic film such as a polyester film (e.g., the polyethylene terephthalate film or the polybutylene terephthalate film) or the polypropylene film, or so-called lint-free paper from which less dust particles are generated (see, for example, JP-B-H6-11959). When the pressure-sensitive adhesive sheet base 22 is constituted from the plastic film or the lint-free paper, dust particles and the like are less likely to be generated when the pressure-sensitive adhesive sheet base 22 is manufactured and used so that electronic components such as relays are less likely to be adversely affected. In addition, when the pressure-sensitive adhesive sheet base 22 is constituted from the plastic film or the lint-free paper, the pressure-sensitive adhesive sheet base 22 can be easily formed into a desired shape by cutting or die cutting when the pressure-sensitive adhesive sheet base 22 is manufactured. Further, in a case where the plastic film is used as the base (the pressure-sensitive adhesive sheet base 22), the polyethylene terephthalate film is particularly preferable as the plastic film because the polyethylene terephthalate film has the advantages that generation of the dust particles is low and that generation of gas during heating is low.

An average thickness of the pressure-sensitive adhesive sheet base 22 is not particularly limited, but is preferably in the range of 5 to 300 μm, and more preferably in the range of 10 to 200 μm.

Printing or typing may be applied to a surface of the pressure-sensitive adhesive sheet base 22 (i.e., a surface opposite to the surface on which the pressure-sensitive adhesive layer 21 is to be laminated). Further, a surface treatment may be made to the surface of the pressure-sensitive adhesive sheet base 22 for the purpose of, for example, improving adhesion of the printing or the typing. Further, the pressure-sensitive adhesive sheet 2 may also serve as a label.

The pressure-sensitive adhesive layer 21 is constituted of a pressure-sensitive adhesive composition mainly containing a pressure-sensitive adhesive.

Examples of the pressure-sensitive adhesive include an acrylic-based pressure-sensitive adhesive, a polyester-based pressure-sensitive adhesive, and an urethane-based pressure-sensitive adhesive.

For example, in a case where the acrylic-based pressure-sensitive adhesive is used as the pressure-sensitive adhesive, the acrylic-based pressure-sensitive adhesive can be constituted of a polymer or a copolymer mainly containing a main monomer component for imparting tackiness, a comonomer component for imparting adhesiveness or cohesive force, and a functional group-containing monomer component for improving crosslinking site or adhesiveness.

In the following, for example, “(meth)acrylic acid” means both “acrylic acid” and “methacrylic acid”, and the other similar terms are used in the same manner.

Examples of the main monomer component include: (meth)acrylic acid alkyl ester such as ethyl (meth)acrylate, n-butyl (meth)acrylate, isobutyl (meth)acrylate, pentyl (meth)acrylate, n-hexyl (meth)acrylate, 2-ethylhexyl (meth)acrylate, octyl (meth)acrylate, cyclohexyl (meth)acrylate and the like.

Examples of the comonomer component include methyl (meth)acrylate, lauryl (meth)acrylate, stearyl (meth)acrylate, tridecyl (meth)acrylate, benzyl (meth)acrylate, 2-methoxyethyl (meth)acrylate, vinyl acetate, styrene, acrylonitrile and the like.

Examples of the functional group-containing monomer component include: a carboxyl group-containing monomer such as (meth)acrylic acid, maleic acid, itaconic acid and the like; a hydroxyl group-containing monomer such as 2-hydroxyethyl (meth)acrylate, 2-hydroxypropyl (meth)acrylate, 4-hydroxybutyl (meth)acrylate and N-methylol (meth)acrylamide and the like; (meth)acrylamide; glycidyl (meth)acrylate and the like.

By containing these components, tackiness and cohesive force of the pressure-sensitive adhesive composition are improved. Further, such an acrylic-based pressure-sensitive adhesive usually has no unsaturated bond in its molecule, and therefore the pressure-sensitive adhesive composition containing the acrylic-based pressure-sensitive adhesive has improved stability with respect to light or oxygen. Further, by appropriately selecting the molecular weight or the kind of monomer, it is possible to obtain a pressure-sensitive adhesive composition having quality and properties suitable for its purpose of use.

The pressure-sensitive adhesive composition may be either of a crosslinked type pressure-sensitive adhesive composition to which crosslinking treatment has been carried out or a non-crosslinked type pressure-sensitive adhesive composition to which crosslinking treatment has not been carried out. However, the crosslinked type pressure-sensitive adhesive composition is preferably used. By using the crosslinked type pressure-sensitive adhesive composition, it is possible to form the pressure-sensitive adhesive layer 21 having further excellent cohesive force.

Examples of a crosslinking agent to be used for the crosslinked type pressure-sensitive adhesive composition include an epoxy-based compound, an isocyanate compound, a metal chelate compound, a metal alkoxide, a metal salt, an amine compound, a hydrazine compound, an aldehyde compound, and the like.

If necessary, the pressure-sensitive adhesive composition to be used in the present invention may contain various additives such as plasticizers, tackifiers, stabilizers, and the like.

An average thickness of the pressure-sensitive adhesive layer 21 is not particularly limited, but is preferably in the range of 5 to 200 μm, and more preferably in the range of 10 to 100 μm.

<Method for Producing Pressure-Sensitive Adhesive Article>

Hereinbelow, one example of a method for producing a pressure-sensitive adhesive article 100 will be described.

First, one example of a method for producing a release sheet 1 which composes the pressure-sensitive adhesive article 100 will be described.

First, a base material 12 is prepared, and a release agent composition as described above is supplied onto the base material 12. Then, by curing it and forming a release agent layer 11, the release sheet 1 is produced.

It is preferable for the release agent composition to be cured by irradiating it with an energy ray. This makes it possible to more easily form the release agent layer 11. Examples of the energy ray include an ultraviolet ray, an electron ray, an X ray, a gamma ray, and the like.

Examples of a method for supplying the release agent onto the base material 12 include various conventional methods such as a gravure coating method, a bar coating method, a spray coating method, a spin coating method, a knife coating method, a roll coating method, a die coating method, and the like.

Hereinbelow, one example of a method for producing a pressure-sensitive adhesive sheet 2 which composes the pressure-sensitive adhesive article 100 will be described.

First, a pressure-sensitive adhesive sheet base 22 is prepared, and then a pressure-sensitive adhesive composition is supplied onto the pressure-sensitive adhesive sheet base 22 to form a pressure-sensitive adhesive layer 21. In this way, the pressure-sensitive adhesive sheet 2 is produced.

Examples of a method for supplying the pressure-sensitive adhesive composition onto the pressure-sensitive adhesive sheet base 22 include various conventional methods such as the gravure coating method, the bar coating method, the spray coating method, the spin coating method, the knife coating method, the roll coating method, the die coating method, and the like.

In this case, the pressure-sensitive adhesive composition may be of a solvent type, an emulsion type, a hot-melt type, or the like.

Then, the thus obtained pressure-sensitive adhesive sheet 2 and release sheet 1 are laminated together so that the pressure-sensitive adhesive layer 21 and the release agent layer 11 are in contact with each other, thereby enabling a pressure-sensitive adhesive article 100 to be obtained.

Alternatively, the pressure-sensitive adhesive article 100 may be produced by forming the pressure-sensitive adhesive layer 21 on the release agent layer 11 of the release sheet 1, and then laminating the pressure-sensitive adhesive sheet base 22 on the pressure-sensitive adhesive layer 21.

Although the release sheet and the pressure-sensitive adhesive article according to the present invention have been described with reference to the preferred embodiments thereof, the present invention is not limited thereto. For example, the pressure-sensitive adhesive article according to the present invention may have a structure such that two pressure-sensitive adhesive layers are formed on both surfaces of the pressure-sensitive adhesive sheet base and release sheets are respectively attached to surfaces of each of the pressure-sensitive adhesive layers.

Further, although the case that the release sheet is composed of the release agent layer and the base material has been described in the above embodiment, the release sheet according to the present invention may be a release agent layer which has the function of the base material as a resin film.

Furthermore, although the pressure-sensitive adhesive article according to the above embodiment has a structure such that the pressure-sensitive adhesive sheet is laminated on the release sheet, the pressure-sensitive adhesive article according to the present invention may have a structure such that the release agent layer is formed on one surface of the base material and the pressure-sensitive adhesive layer is formed on the other surface of the base material.

The applications of the release sheet and the pressure-sensitive adhesive article according to the present invention are not limited to the above-mentioned electric components such as relays, various switches, connectors, motors, hard disk drives, and the like.

### EXAMPLES

Next, specific examples according to the present invention will be described.

1. Production of Release Sheet

### Example 1

(Production of Undercoat Layer)

100 mass parts of polyester polyol (manufactured by Dainippon Ink and Chemicals, Incorporated, trade name: Crisbon 5150S, solid content: 50 mass %) and 5 mass parts of an isocyanate compound (manufactured by Dainippon Ink and Chemicals, Incorporated, trade name: Crisbon NX) were diluted with a methyl ethyl ketone solvent to obtain a solution having a solid concentration of 1 mass %. The obtained solution was coated on a PET film (manufactured by Mitsubishi Chemical Polyester Film, trade name: PET 50-T 100) having a thickness of 50 μm to form a coating film of which film thickness after drying was about 0.1 μm.

Thereafter, the formed coating film was dried at 100° C. for 1 minute to form an undercoat layer constituted of a polyurethane-based resin.

(Production of Release Agent Layer)

1 mass part of a hindered phenol antioxidant (manufactured by Ciba Specialty Chemicals Inc., trade name: Irganox HP2251) was added to 100 mass parts of polybutadiene (manufactured by Ube Industries, Ltd., trade name: UBEPOL-BR150, mass average molecular weight: 540,000), and then they were diluted with a toluene solvent to obtain a release agent composition having a solid content concentration of 1.0 mass %.

The obtained release agent composition was coated on the undercoat layer. Then, by drying it at 100° C. for 60 seconds, a coating layer was obtained.

Subsequently, the coating layer was irradiated with an ultraviolet ray using a belt conveyor type ultraviolet irradiation device with 1 lamp of fusion H bulb 240 w/cm being an electrodeless lamp under the condition (ultraviolet irradiation condition: 100 mJ/cm²) of a conveyor speed of 40 m/min to cure the coating layer. Thereby, a release sheet which was provided with a release agent layer having a film thickness of 0.1 μm was obtained.

In this regard, a content of cis-1,4-butadiene as a monomer in the polybutadiene of this Example was 98 mol %. The content (ratio) of the monomer was measured by an infrared absorption spectrum method (ATR method).

### Example 2

A release sheet was produced in the same manner as in Example 1 except that UBEPOL-BR150B (mass average molecular weight: 500,000) manufactured by Ube Industries, Ltd. was used as the polybutadiene. In this regard, the content of the cis-1,4-butadiene as the monomer in the polybutadiene of this Example was 97 mol %.

### Example 3

A release sheet was produced in the same manner as in Example 1 except that UBEPOL-BR130B (mass average molecular weight: 430,000) manufactured by Ube Industries, Ltd. was used as the polybutadiene. In this regard, the content of the cis-1,4-butadiene as the monomer in the polybutadiene of this Example was 96 mol %.

### Comparative Example 1

A release sheet was produced in the same manner as in Example 1 except that polybutadiene obtained in the following manner was used as the polybutadiene.

5.4 kg of 1,3-butadiene was placed in a 20-L autoclave equipped at the top with a reflux condenser cooled with liquid ammonium.

On the other hand, 1.2 mmol of nickel naphthenate, 7.3 mmol of boron trifluoride etherate, and 6.6 mmol of n-butyl lithium were dissolved in this order in 250 mL of toluene, from which moisture had been removed, to prepare a toluene solution.

This toluene solution was fed into the autoclave to initiate a polymerization reaction.

The polymerization reaction was initiated at 30° C.

After a lapse of 30 minutes, 50 mL of isopropyl alcohol was added into the autoclave to terminate the reaction. The reaction was terminated at 50° C.

Then, the inner pressure of the autoclave was reduced to atmospheric pressure, and a residual monomer was removed from a reaction product by flashing. Then, the reaction product was dried to obtain the polybutadiene.

The Mooney viscosity (ML₁₊₄ (100° C.)) of the polybutadiene was 44. A mass average molecular weight of the polybutadiene was 360,000. The content of the cis-1,4-butadiene as the monomer in the polybutadiene was 96.0 mol %.

### Comparative Example 2

A release sheet was produced in the same manner as in Example 1 except that UBEPOL-BR150L (mass average molecular weight: 520,000) manufactured by Ube Industries, Ltd. was used as the polybutadiene. In this regard, the content of the cis-1,4-butadiene as the monomer in the polybutadiene of this Example was 98 mol %.

### Comparative Example 3

A release sheet was produced in the same manner as in Example 1 except that UBEPOL-BR230 (mass average molecular weight: 630,000) manufactured by Ube Industries, Ltd. was used as the polybutadiene. In this regard, the content of the cis-1,4-butadiene as the monomer in the polybutadiene of this Example was 98 mol %.

The release agent layers of the release sheets of each Example and each Comparative Example contained substantially no silicone compound.

2. Production of Pressure-sensitive Adhesive Article

An adhesive (manufactured by Toyo Ink, trade name “BPS-5127”) was coated on the release agent layer of the release sheet obtained in each of Examples and Comparative Examples using an applicator. Thereby, a coating film was formed.

Next, the formed coating film was dried by heating at 100° C. for 60 seconds to form a pressure-sensitive adhesive layer having a thickness of 25 μm. A PET film (manufactured by Mitsubishi Chemical Polyester Film, trade name: PET50-T100) having a thickness of 50 μm as a pressure-sensitive adhesive sheet base was laminated thereon to obtain a pressure-sensitive adhesive article.

3. Evaluation

[Release Force Test]

For each of the pressure-sensitive adhesive articles with the release sheets of the Examples 1 to 3 and the Comparative Examples 1 to 3, a release force was measured. It is to be noted that the release force was measured after the pressure-sensitive adhesive articles were left stand in an atmosphere of 23° C. and 50% RH for 1 day.

The release force was measured in an atmosphere of 23° C. and 50% RH by using the pressure-sensitive adhesive article cut into the width of 50 mm and the length of 200 mm. Further, the release force of the pressure-sensitive adhesive sheet was measured by using a tensile tester to which the release sheet of the pressure-sensitive adhesive article was fixed and by pulling the pressure-sensitive adhesive sheet at a predetermined peel rate in a 180° direction. In this release force test, the release force was measured at peel rates of 0.3 m/min, 10 m/min, and 30 m/min, respectively.

[Zipping Evaluation]

For each of the pressure-sensitive adhesive articles with the release sheets of the Examples 1 to 3 and the Comparative Examples 1 to 3, surface condition of the pressure-sensitive adhesive layer after peeling the pressure-sensitive adhesive sheet from the release sheet was visually observed and evaluated according to the following criteria. Evaluation was carried out at a peel rate of 10 m/min.

A: No deformation was observed on the surface of the pressure-sensitive adhesive layer which had been in contact with the release agent layer, and the surface condition was smooth.

B: Deformation occurred on the surface of the pressure-sensitive adhesive layer which had been in contact with the release agent layer, and streaks and the like were visually observed.

These results were shown in Table 1 with the Mooney viscosity ML₁₊₄ (100° C.) of the diene-based polymer, the viscosity (T_{Cp}) of the toluene solution, the ratio (T_{Cp}/ML₁₊₄ (100° C.)), and the Young's modulus measured by the force curve measurement method in each of the Examples and the Comparative Examples.

TABLE 1

| | | | | | | | | Zipping Evaluation | |
|---|---|---|---|---|---|---|---|---|---|
| | | | | E_{AVE} | Release force (mN/50 mm) | | | Release force | Surface |
| | T_{Cp} | ML₂₊₄ | T_{Cp}/ML₂₊₄ | (MPa) | 0.3 m/min | 10 m/min | 30 m/min | change ratio (%) | condition |
| Example 1 | 75 | 43 | 1.8 | 2.18 | 330 | 810 | 940 | <5 | A |
| Example 2 | 48 | 40 | 1.2 | 1.78 | 290 | 720 | 880 | <5 | A |
| Example 3 | 30 | 29 | 1.0 | 1.25 | 310 | 730 | 980 | <5 | A |
| Comparative Example 1 | 150 | 44 | 3.4 | 2.35 | 300 | 780 | 1100 | 14.9 | B |
| Comparative Example 2 | 105 | 43 | 2.4 | 2.57 | 340 | 860 | 1070 | 17.1 | B |
| Comparative Example 3 | 117 | 38 | 3.1 | 2.53 | 380 | 830 | 1020 | 16 | B |

As can be seen from Table 1, the release sheet according to the present invention had the small dependence of the release force on the peel rate. In addition, it was possible to suppress the occurrence of the zipping phenomenon in the release sheet according to the present invention. On the other hand, in the cases of the release sheets of the Comparative Examples 1 to 3, satisfactory results could not be obtained. Further, the release sheet (pressure-sensitive adhesive article) according to the present invention did not contain a silicone compound. This indicated that the release sheet (pressure-sensitive adhesive article) according to the present invention was hard to give the adverse effects to the electric components such as relays.

### INDUSTRIAL APPLICABILITY

A release sheet according to the present invention includes a base material and a release agent layer provided on the base material. The release agent layer is composed of a cured product of a release agent composition containing 50 mass % or more of a diene-based polymer. Mooney viscosity (ML₁₊₄ (100° C.)) of the diene-based polymer measured at 100° C. according to JIS K6300 is in the range of 25 to 70, and a ratio (T_{Cp}/ML₁₊₄ (100° C.) of the Mooney viscosity (ML₁₊₄ (100° C.)) and a viscosity (T_{Cp}) of a toluene solution of the diene-based polymer is 2.2 or less. This makes it possible to provide a release sheet which can sufficiently suppress adverse effects on electric components and the like and which has a small dependence of release force on peel rate and which can suppress the occurrence of zipping phenomenon, and a pressure-sensitive adhesive article having such a release sheet. Therefore, the present invention has industrial applicability.

### EXPLANATION OF REFERENCE NUMERAL

100: pressure-sensitive adhesive article
1: release sheet
11: release agent layer
12: base material
13: undercoat layer
2: pressure-sensitive adhesive sheet
21: pressure-sensitive adhesive layer
22: pressure-sensitive adhesive sheet base

1. A release sheet, comprising:
a base material; and
a release agent layer provided on the base material,
wherein the release agent layer is composed of a cured product of a release agent composition containing 50 mass % or more of a diene-based polymer,
wherein Mooney viscosity (ML₁₊₄ (100° C.)) of the diene-based polymer measured at 100° C. according to JIS K6300 is in the range of 25 to 70, and
wherein a ratio (T_{Cp}/ML₁₊₄ (100° C.)) of the Mooney viscosity (ML₁₊₄ (100° C.)) and a viscosity (T_{Cp}) of a toluene solution of the diene-based polymer is 2.2 or less.

2. The release sheet as claimed in claim 1, wherein an amount of a silicone compound contained in the release agent layer is measured by X-ray photoelectron spectroscopy (XPS), and the amount is 0.5 atomic % or less.

3. The release sheet as claimed in claim 1, wherein the diene-based polymer contains cis-1,4-butadiene as a monomer.

4. The release sheet as claimed in claim 3, wherein a content of the cis-1,4-butadiene as the monomer in the diene-based polymer is 90 mol % or more.

5. The release sheet as claimed in claim 1, wherein the diene-based polymer has a mass average molecular weight of 100,000 to 600,000.

6. The release sheet as claimed in claim 1, wherein the release agent layer has an average thickness of 0.01 to 1.0 μm.

7. The release sheet as claimed in claim 1 further comprising an undercoat layer provided between the base material and the release agent layer.

8. The release sheet as claimed in claim 7, wherein the undercoat layer is constituted of a material containing a polyurethane-based resin.

9. The release sheet as claimed in claim 1, wherein the cured product of the release agent composition is formed by irradiating the release agent composition with an energy ray.

10. The release sheet as claimed in claim 1, wherein the base material is one kind selected from the group consisting of paper, laminated paper obtained by laminating a thermoplastic resin on the paper, a plastic film, and a laminated sheet including them.

11. A pressure-sensitive adhesive article, comprising:
a release sheet including:
a base material; and
a release agent layer provided on the base material;
wherein the release agent layer is composed of a cured product of a release agent composition containing 50 mass % or more of a diene-based polymer;
wherein Mooney viscosity (ML₁₊₄ (100° C.)) of the diene-based polymer measured at 100° C. according to JIS K6300 is in the range of 25 to 70; and
wherein a ratio (T_{Cp}/(100° C.)) of the Mooney viscosity (ML₁₊₄ (100° C.)) and a viscosity (T_{Cp}) of a toluene solution of the diene-based polymer is 2.2 or less; and
a pressure-sensitive adhesive sheet adhered to the release sheet, the pressure-sensitive adhesive sheet having a pressure-sensitive adhesive layer that is in physical contact with the release agent layer.

12. The pressure-sensitive adhesive article as claimed in claim 11, wherein the pressure-sensitive adhesive layer is constituted of at least one kind selected from the group consisting of an acrylic-based pressure-sensitive adhesive, a polyester-based pressure-sensitive adhesive, and an urethane-based pressure-sensitive adhesive.
